(19) United States
(12) Patent Application Publication
(10) Pub. No.: US 2011/0088619 A1
(43) Pub. Date: Apr. 21, 2011

(54) Unrolling Device for a Material Web

(75) Inventor: Peter Duerrstein, Bietigheim-Bissingen (DE)

(73) Assignee: Duerr Optronik GmbH & Co. KG, Gechingen (DE)

(21) Appl. No.: 12/905,504

(22) Filed: Oct. 15, 2010

(30) Foreign Application Priority Data
Oct. 19, 2009 (DE) 202009014152.7

(51) Int. Cl. A47K 10/38; A47K 10/24; B05C 5/00

(52) U.S. Cl. 118/696; 242/564.1

(57) ABSTRACT

A towel dispenser which sprays portions of a material web pulled off from a supply roll with a disinfectant. A disinfectant supply bottle is arranged partially inside a core of the supply roll, and its liquid outlet is connected to the inlet of a diaphragm pump, which feeds into a nozzle pipe. To measure the residual material web remaining on the supply roll, an angular velocity transmitter is used which comprises a stationary reflective light barrier and a line pattern applied to the inside of the core of the supply roller.

### RELATED APPLICATIONS

This application claims the filing benefit of German Patent Application No. 20 2009 014 152.7 filed Oct. 19, 2009 the contents of which are incorporated herein by reference.

### FIELD OF THE INVENTION

The invention relates generally to an unrolling device for a material web.

### BACKGROUND OF THE INVENTION

Unrolling devices for material webs are used in various fields of the technology, but also in the field of sanitation and in the household, e.g. in the form of devices which pull off and separate pieces from a continuous paper web (e.g. towel dispensers).

Unrolling devices of this type are often mechanically actuated, and the length of the respective pulled-off portion of the material web is determined by mechanical stops.

Altering the length of the desired web portions can be realised only by mechanical intervention in the unrolling device.

The present invention is directed to resolving these and other matters.

### SUMMARY OF THE INVENTION

The present invention is therefore intended to develop an unrolling device in such a way that a simple adjustment to the length of the delivered material piece is possible.

This object may be achieved according to the invention by an unrolling device having the features of one of more embodiments of the devices disclosed herein.

In the unrolling device according to the invention, the length of the delivered web piece can be adjusted simply by presetting a specified path for the pull-off procedure or and/by presetting a specified time for the pull-off procedure.

Advantageous developments of the invention are the subject matter of subclaims.

In an unrolling device according to one embodiment, on the path between the pull-off point and the delivery point, the pulled-off material web can be provided with a medium which is held in a supply bottle. This is accommodated in the core of the supply roll, which core may be constructed on a somewhat larger scale, so that the supply bottle can be accommodated in the unrolling device without noticeably increasing its outer contour.

In an unrolling device according to another embodiment, the supply bottle is accommodated in fixed manner in the housing and can therefore at the same time serve as a core carrier on which the supply roll is mounted.

In an unrolling device according to another embodiment, the supply bottle does not need to be arranged in torsion-resistant manner in the device, which makes it easier to change. The torque generated during the unrolling from the supply roll is absorbed by a core carrier which is arranged between the inner face of the core of the supply roll and the outer face of the supply bottle.

The development of the invention according to another embodiment enables particularly simple removal of an empty core and insertion of a new supply roll by taking out and reinserting the core carrier.

The development of the invention according to another embodiment is advantageous in terms of the readily meterable and uniform distribution of the medium to be applied on the surface of the material web.

In an unrolling device according to another embodiment, it can be very easily established whether sufficient medium is applied to the material web. It is namely possible to easily and reliably determine from the current flowing through the pump whether the pump is still delivering or is completely or partially empty.

The development of the invention according to another embodiment also serves to monitor whether the material web is correctly provided with medium. This is particularly important when the medium applied is intended to fulfil hygiene-related requirements, e.g. is a disinfectant. Here, an insufficient supply of disinfectant would result in residues of bacteria and viruses still remaining on the surfaces to be disinfected.

The development of the invention according to another embodiment enables the actual radius of the residual reel of the supply roll to be calculated from the comparison between the predetermined pull-off speed of the material web and the angular velocity of the supply roll, which then enables the percentage of the material web remaining on the supply roll to be easily determined. To the same end, it is also possible to compare the pull-off path of the material web and the angle of rotation of the core.

The development of the invention according to another embodiment enables the angular velocity or the angular position of the supply roll to be measured with a sensor, for which no mechanical connections whatsoever have to be produced between the supply roll and a fixed device part. This transmitter has a very simple and robust construction and inevitably arrives in the operational state when a supply roll is inserted.

By using different mark arrangements, it is also possible to recognise different types of supply roll by way of the angle (angular velocity) transmitter since, with a predetermined pull-off speed per unit time, for example, a different number of lines is detected or the geometry of the marks is different etc. The angle (angular velocity) transmitter can therefore serve at the same time to recognise the type of supply roll.

The development of the invention according to another embodiment serves for the determination (already mentioned above) of the residual material web remaining on the supply roll.

The development of the invention according to another embodiment ensures that the user is made aware that the material web is coming to an end and/or the pull-off device is stopped so that no more material web is delivered.

In an unrolling device according to another embodiment, the supply bottle is aligned horizontally so that a supply roll can be arranged over it with the conventional horizontal alignment of its axis. The supply bottle here is constructed in such a way that medium inside it can flow out under gravitational force without any residue remaining.

The development according to another embodiment ensures that the supply bottle can only be inserted in the unrolling device in an angular position in which its sloping wall portion is at the bottom.

In an unrolling device according to another embodiment, the supply bottle is arranged with a vertical axis. It can therefore be particularly easily inserted into the device and removed from it. With typical bottle geometries, this arrangement results in the bottle being emptied completely even without a special geometry. The supply bottle can again itself form a core carrier on which the supply roll rotates as the material web is pulled off. As a result of providing a deflection roller which is preferably set at 45°, the material web is also delivered vertically downwards with this geometry of the arrangement of the supply bottle and supply container.

In an unrolling device according to another embodiment, it is possible to separate the nozzle pipe and its fluid supply from one another at the nozzle pipe (e.g. for replacing the supply bottle) without any noticeable escape of fluid.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 is a schematic partially vertically sectional view of a dispenser for paper towels soaked with disinfectant;

FIG. 2 is an axial plan view of a core carrier of the towel dispenser shown in FIG. 1, together with a holding part by way of which the core carrier is detachably mounted on the housing of the towel dispenser;

FIG. 3 is a plan view of a section of the unrolled inner face of the core of the supply roll of FIG. 1; and

FIG. 4 is a vertical section through a modified towel dispenser with a vertically aligned axis of the supply bottle and supply roll.

### DETAILED DESCRIPTION OF THE PRESENT INVENTION

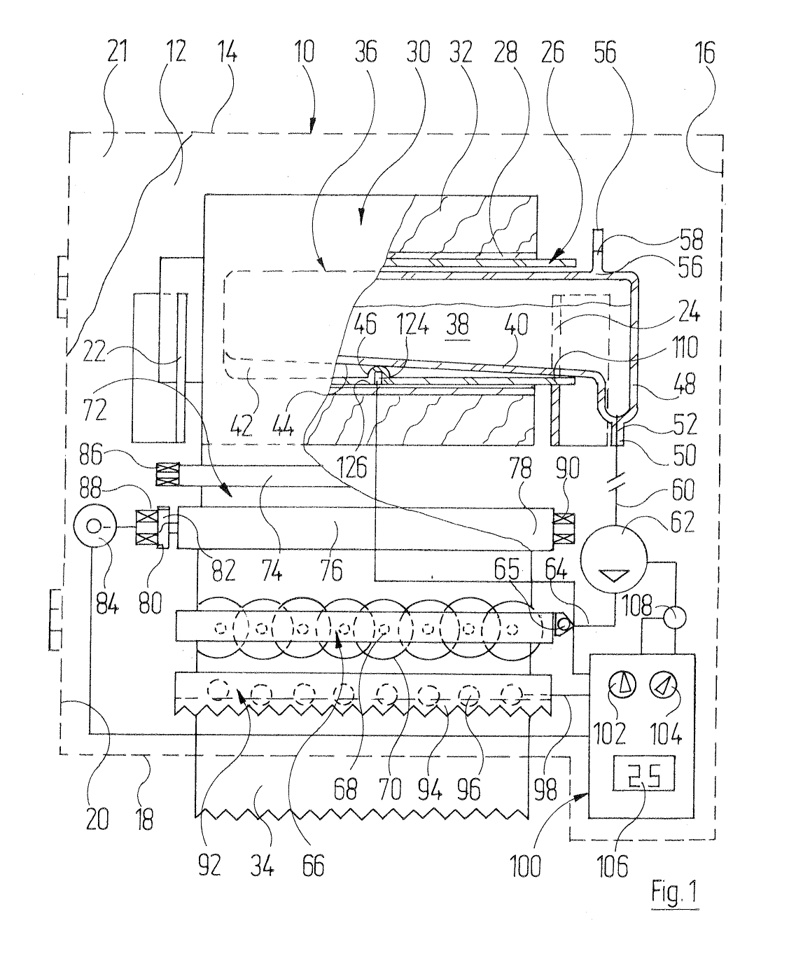

In FIG. 1, the housing of a towel dispenser is denoted schematically by 10 and has a rear wall 12, side walls 14, 16, 18, 20 and a door 21, which is for the most part broken away and is attached on the left-hand side.

The rear wall 12 supports two holding parts 22, 24 constructed as minor images for a tubular core carrier 26. A core 28 of a supply roll (denoted as a whole by 30) runs on the core carrier 26 and carries a reel 32 of a web 34 of a pulp material.

A supply bottle 36 is arranged inside the core carrier 26. A volume 38 of a disinfectant is located in said supply bottle.

The supply bottle 36 has a substantially cylindrical form, although a base wall 40 (located at the bottom in FIG. 1) is planar and extends obliquely upwards to the left. Integrally formed on the underside of the base wall 40 are two spaced base ribs 42 which delimit a positioning groove 44 between them.

A spherical projection 46, which is integrally formed on the inner face of the core carrier 26, engages with sliding play in the positioning groove 44.

As shown in FIG. 1, the supply bottle 36 extends axially to the right beyond the end of the core carrier 26 and has a lower blunt portion 48 there on which a delivery connection 50, which comprises a delivery bore 52, is integrally formed.

A vent connection 54 is provided in the upper portion of the projecting part of the supply bottle 36. This vent connection contains a fine vent channel 56 and is fused on in air-tight manner in the factory.

By breaking off an upper end portion of the vent connection 54 at a specified break point 58, the vent channel 56 can be brought into communication with the surrounding atmosphere.

The delivery connection 50 is connected to the inlet of a diaphragm pump 62 by way of a flexible line 60 (only indicated schematically), in practice a flexible hose which is pushed onto the vent connection 54.

The outlet of the diaphragm pump 62 is connected to a nozzle pipe 66 by way of a line 64 and a pressure-relief valve 65, which nozzle pipe is provided on its rear wall portion (as seen in FIG. 1) with a plurality of nozzle openings 68 which face the upper side of the material web 34 pulled off from the supply roll 30. The pressure-relief valve 65 is arranged directly in front of the nozzle pipe 66 at the end of the line 64 so that, between it and the nozzle pipe, there is no appreciable quantity of liquid which could escape when the line 64 is removed.

Instead of a pressure-relief valve 65, in a modification it is also possible to provide a solenoid valve which is pre-stressed in the closed state and is activated (possibly capacitively) when the diaphragm pump 62 is triggered.

In FIG. 1, 70 denotes spray cones which create the individual nozzle openings 68 when the diaphragm pump 62 delivers pressurised disinfectant.

As shown in the drawing, the spray cones 70 overlap in the transverse direction of the material web 34 so that this is sprayed substantially uniformly with disinfectant over the entire width.

To supply the material web 34 to the nozzle pipe 66, a drive unit (denoted as a whole by 72) is provided. This comprises an inlet-side deflection roller 74 which deflects the material web 34 pulled off from the supply roll 30 into a delivery plane (here the plane of the drawing). A pair of rollers 76, 78, which are arranged in alignment above one another and are coupled by gear wheels 80, 82 for synchronous movement in opposite directions, further belongs to the drive unit 72. A stepping motor 84 drives the upper roller 76 in the drawing.

Bearings for the deflection roller 74 are denoted by 86, bearings for the rollers 76, 78 are denoted by 88 and 90.

Provided downstream of the nozzle pipe 66 is a toothed cutting body 92 which is made from an insulating plastic material. A sharp metal cutting strip 94 is inserted into the cutting body 92.

On the underside, the cutting body 92 supports disc-shaped electrodes 96 which (not illustrated in more detail) are connected to one another in such a way that differently polarised voltages in each case are applied to successive electrodes 96 so that creeping currents flow between the electrodes 96 when the material web 34 is dampened correctly 34. These creeping currents are transmitted by way of a cable 98 to a control unit 100 which controls the diaphragm pump 62 and the stepping motor 84.

The control unit 100 also monitors how much material web is still on the supply roll 30, whether sufficient liquid is supplied to the nozzle pipe 66 and, as explained, whether the material web 34 downstream of the nozzle pipe 66 is sufficiently dampened.

Moreover, some of the operating parameters of the towel dispenser can be set at the control unit 100. For example, an adjusting knob 102 is shown with which the length of the delivered web portions (towels) can be set, furthermore an adjusting knob 104 with which the quantity of the delivered disinfectant can be set, where the one end position of the adjusting knob corresponds to full interruption to the supply of disinfectant.

A display 106 of the control unit 100 enables the operating parameters set by the user to be indicated and, if errors occur, error codes which characterise these to be shown. It is also possible to use a controllable noise source (not illustrated) to emit different acoustic alarms.

The control unit 100 also cooperates with a current sensor 108 which is connected in the supply line to the diaphragm pump 62. By monitoring the pump current, it is continuously possible to determine whether the diaphragm pump 62 is delivering or empty.

The feed quantity of the diaphragm pump 62 can be adjusted by way of the frequency and amplitude of the alternating current supplied to the diaphragm pump 62.

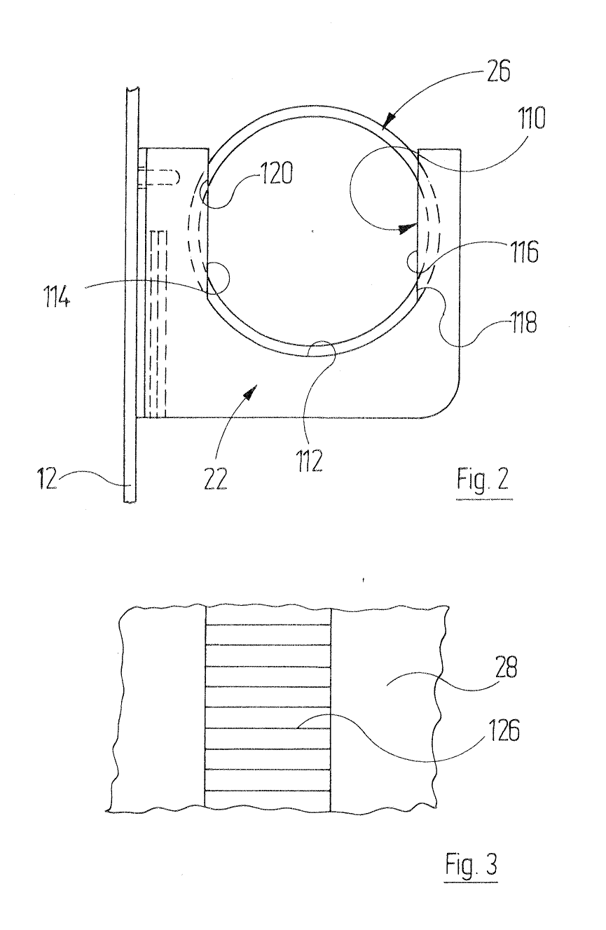

As shown in FIG. 2, the holding part 22 has an upwardly open cutout 110 having an arcuate base portion 112 whereof the radius corresponds to the outer radius of the core carrier 26, and two parallel vertical wall portions 114, 116 which are linear and extend into opposing vertical slots 118, 120 provided on opposite sides of the core carrier 26.

The core carrier 26 is thus mounted in the holding part 22 such that it is torsion-resistant yet removable in the vertical direction. The holding part 24 is constructed as a minor image of the holding part 22 and the right-hand end of the core carrier 26 (as seen in FIG. 1) has slots 118, 120 in the same manner as the end of the core carrier 26 which is situated on the left-hand side in FIG. 1. These slots are aligned with one another as seen in the axial direction.

The holding parts 22 and 24 are fixedly mounted on the rear wall 12 of the housing 10, and the core carrier 26, together with the supply bottle 36 located in it, can be removed upwards out of the holding parts 22, 24 since the line 66 between the supply bottle 36 and the diaphragm pump 62 is appropriately long.

The supply roll 30 (where necessary) and/or the supply bottle (where necessary) can then be removed from the core carrier 26 and replaced with a new supply roll 30 or a new supply bottle 36. The core carrier 26, together with the supply roll and supply bottle, is then reinserted into the holding parts 22, 24 from above.

To continuously obtain information relating to how much material web is still in the reel 32, a reflective light barrier 124, which is connected to the control means 100, is provided inside the projection 46. The reflective light barrier 124 cooperates with a line pattern 126 which is provided on the inner face of the core 28, and more precisely approximately in its centre. The line pattern 126 can be generated by printing a corresponding line pattern 126 as the innermost layer of the reel core which is rolled from gummed paper. A section of this line pattern is shown in FIG. 3.

Instead of a line pattern, it is also possible to use a set of marks with a different geometry. The marks can also be provided on a self-adhesive strip and applied to an axial end of the inner face of the core 28. The marks can also be grooves or depressions which are impressed into the inside of the core 28. Hole patterns, which are punched into the core 28, can also serve as marks.

As the material web 34 is pulled off, the supply roll 30 and with it also the line pattern 126, rotates accordingly. If the supply roll 30 is still full, the angular velocity of the rotation as a predetermined length of the material web is pulled off is low, correspondingly few lines of the line pattern 126 pass the reflective light barrier 124. The smaller the diameter of the residual reel, the more lines pass the reflective light barrier 124 as a towel is pulled off.

The control unit 100 comprises a read only memory in which, for all time intervals between line pulses which will continue as the supply roll 30 is unrolled, the remainder of the material web still on the reel 30 is given as a percentage of the original supply.

This table can be obtained in the first instance by experiment. However it is also possible to provide a calculating circuit in the control unit 100, which calculates the radius of the residual reel from the known pull-off speed of the material web and the measured spacing between successive line pulses. It can then convert this radius into the residual length of the material web located on the reel whereupon, taking into account the change in diameter for a full revolution of the supply roll, it is also possible to determine the thickness of the material web and use this for the calculation. When using a calculating circuit of this type, predetermined tables are therefore unnecessary.

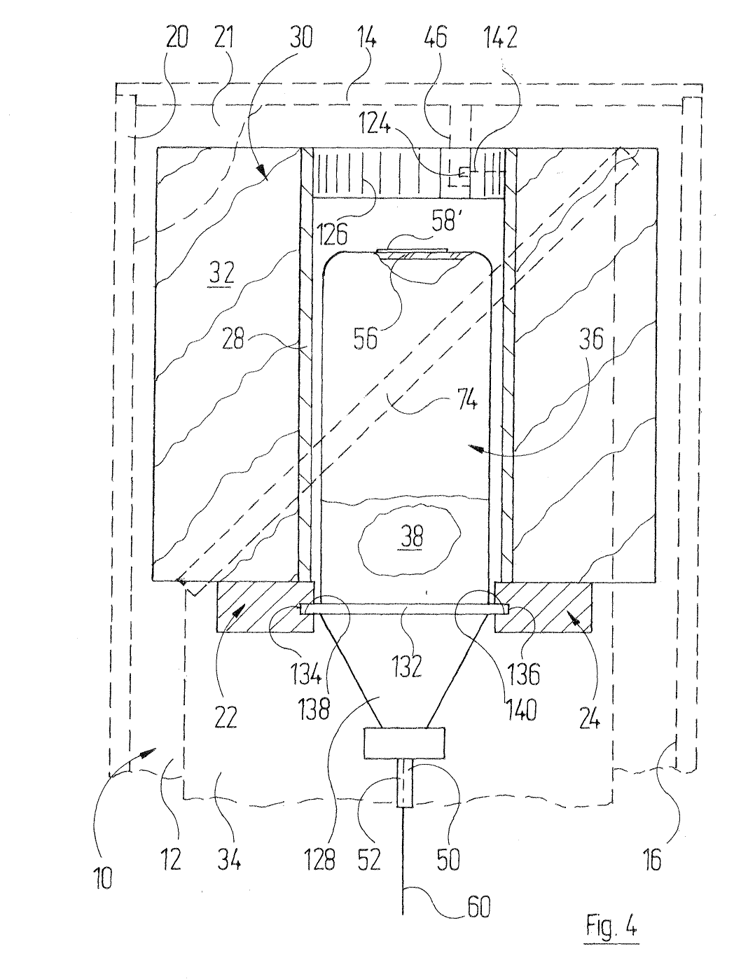

In the modified towel dispenser in FIG. 4, only that part of the dispenser showing the arrangement of the supply roll and supply bottle is illustrated. The other parts of the towel dispenser should be added mentally according to FIG. 1.

In the exemplary embodiment according to FIG. 4, components which have already been explained above with reference to FIGS. 1 to 3 are again provided with the same reference numerals, even when they differ in terms of geometrical details.

In the towel dispenser according to FIG. 4, the supply bottle 36 has a cylindrical basic form and is arranged vertically. A lower conical tapered portion 128 (as seen in FIG. 4) is closed by a screw cap 130 which supports a delivery connection 50. This can be constructed similarly to the vent connection 54 according to FIG. 1. After pushing a stepped hose end onto it, part of the delivery connection can be broken off at a specified break point.

At the transition point between the cylindrical base body and the conical end portion 128, the supply bottle 36 is provided with a holding flange 132 which has a circular basic form, although two opposing sides are provided with flattened portions 134, 136. These flattened portions of the holding flange 132 are pushed into grooves 138, 140 in two holding parts 22, 24 which are again connected to the rear wall 12 of the housing 10.

It is thus possible to remove the supply bottle in a slightly forward direction from the housing 10 and also to insert it from a slightly forward position back into the housing 10.

The cylindrical base body of the supply bottle 36 is now at the same time the bearing for the core 28 of the supply roll 30.

This is now arranged accordingly with a vertical axis in the housing 10.

The pulled-off material web 34 is deflected into the vertical downwards direction by way of a deflection roller 74 set at 45°. It then runs further to the drive unit 72, to the nozzle pipe 66 and to the cutting body 92, as described above. The material web is driven and sprayed in particular in the manner described in connection with FIG. 1.

In the exemplary embodiment according to FIG. 4, the reflective light barrier 124 is supported by a projection 46 which is provided on a cover 142 of the housing 10. The line pattern 126 is now provided in the vicinity of the upper end of the core 28 and cooperates with the beam (denoted by 144) of the reflective light barrier 124.

It is clear that, with the towel dispenser described above, a reliable uniform dampening of towels separated from a material web is achieved, the intensity of which can be readily adjusted.

It is furthermore clear that, with the towel dispenser described above, precise measurement of the residual material web remaining on the reel of the supply roll is possible without a tactile sensor which measures the actual outer diameter of the reel having to cooperate with the outside of the supply roll. When replacing the supply roll, a sensor of this type would firstly have to be lifted and moved out of the path covered by the supply roll upon removal and insertion. Also, with the manner of determining the residual quantity of material web described above, the solution is improved precisely in the critical area in which there is only little residual material web remaining on the core, since the angular velocity of the core increases towards the end of material web.

It is furthermore clear that the towel dispenser according to the invention is notable for a very compact construction.

What is claimed is:

1. An unrolling device for a material web comprising:
a supply roll having a core and a reel of a web material arranged on said core;
a pull-off device, which feeds the material web from the supply roll to a delivery point, wherein the pull-off device is actuated by a control means in dependence on a time and/or in dependence on a feed path of the material web.

2. The unrolling device of claim 1, wherein a supply bottle is at least partially arranged in the core of the supply roll, wherein the supply bottle contains a medium which is applied to the material web on a path from the supply roll to the delivery point.

3. The unrolling device of claim 2, wherein a positive, clamping or frictional connects the supply bottle with a holding device connected to a housing.

4. The unrolling device of claim 2, wherein a core carrier is arranged between an outer face of the supply roll and an inner face of the core, which core carrier is connected, preferably detachably, to a housing.

5. The unrolling device of claim 4, wherein the core carrier is connected to a housing in plug-in or pivotable manner.

6. The unrolling device of claim 1, further comprising: a pump which draws off from the supply bottle and feeds into a nozzle pipe which has nozzle openings facing a feed face of the material web.

7. The unrolling device of claim 6, wherein a current sensor which measures a current through the pump and by a control circuit, which is acted upon by an actual current signal provided by the current sensor and which generates an alarm and/or stops the pull-off device when the actual current drawn deviates from a specified current.

8. The unrolling device of claim 6, wherein a sensor device which is arranged downstream of the nozzle pipe and reacts to a presence of the medium applied to the material web and by a control circuit, which is acted upon by an output signal of the filling device and generates an alarm and/or stops the pull-off device when the output signal of the filling device deviates from a specified value.

9. The unrolling device of claim 1, wherein the supply roll cooperates with an angle transmitter or angular velocity transmitter.

10. The unrolling device of claim 9, wherein the angle transmitter or angular velocity transmitter has marks applied to the core and a mark sensor cooperating with said marks.

11. The unrolling device of claim 9, wherein a residual reel calculating circuit, which calculates a diameter of a residual reel and/or a residual length of the material web remaining on the residual reel from a pull-off speed, a pull-of length or a pull-off time of the pull-off device on the one hand and an output signal of the angular velocity transmitter or the angle transmitter on the other.

12. The pull-off device of claim 11, wherein a control circuit, which is acted upon by a residual-reel signal of the calculating circuit and generates an alarm signal and/or stops the pull-off device when the residual-reel signal falls short of a predetermined value and/or the output signal of the angular velocity transmitter is zero.

13. The unrolling device of claim 2, wherein an axis of the supply roll is aligned horizontally and the material web is pulled off substantially vertically downwards from it, and in that the supply bottle is arranged in a predetermined angular position in the core and has a wall portion which is located at a bottom of the supply bottle and slopes at an angle downwards to a removal portion of the supply bottle, and wherein a delivery connection is provided.

14. The unrolling device of claim 13, wherein the supply bottle has two spaced guide ribs placed on the underside of the wall portion located at the bottom, which guide ribs receive a guide projection between them, which is arranged on a core carrier arranged between the supply bottle and the core and comprises a mark reader.

15. The unrolling device of claim 2, wherein the supply bottle has holding means with which it is detachably mounted in vertical alignment on a housing, and in that the supply roll is rotatably placed on the supply bottle, wherein the material web is pulled off from the supply roll by way of a 45° deflection roller.

16. The unrolling device of claim 2, wherein the supply bottle is connected to a nozzle pipe by way of a line which has a closing valve at the end adjacent to the nozzle pipe.
